(19) United States
(12) Patent Application Publication
(10) Pub. No.: US 2017/0187111 A1
(43) Pub. Date: Jun. 29, 2017

(54) RESONANT FREQUENCY TUNABLE ANTENNA

(71) Applicant: LG ELECTRONICS INC., Seoul (KR)

(72) Inventors: Jaewon NOH, Seoul (KR); Kyungcheol PAEK, Seoul (KR)

(73) Assignee: LG ELECTRONICS INC., Seoul (KR)

(21) Appl. No.: 15/508,902

(22) PCT Filed: Jul. 8, 2015
(86) PCT No.: PCT/KR2015/007056

§ 371 Date: Mar. 3, 2017

(30) Foreign Application Priority Data
Sep. 5, 2014 (KR) 10-2014-0119218

(51) Int. Cl. H01Q 5/335; H01Q 9/04; H01Q 1/48; H01Q 1/24

(52) U.S. Cl. CPC H01Q 5/335; H01Q 1/243; H01Q 9/0421; H01Q 1/48

(57) ABSTRACT

The present invention relates to a resonant frequency tunable antenna, and may provide a resonant frequency tunable antenna which comprises: a first ground part; a power supply part connected in the longitudinal direction of the antenna from the first power supply part; and a second ground part connected in the longitudinal direction of the antenna from the power supply part, wherein the second ground part is a variable ground part, the second ground part and the power supply part are connected by a switch, and the switch is connected to a common terminal which is grounded, so that the second ground part and the power supply part are linked and controlled.

### TECHNICAL FIELD

The present disclosure relates to a resonant frequency tunable antenna, and more particularly, a resonant frequency tunable antenna, capable of controlling a resonant frequency for using a multiband in a mobile communication system.

### BACKGROUND ART

Terminals may be divided into mobile/portable terminals and stationary terminals according to their mobility. Also, the mobile terminals may be classified into handheld terminals and vehicle mount terminals according to whether or not a user can directly carry.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As it becomes multifunctional, a mobile terminal can be allowed to capture still images or moving images, play music or video files, play games, receive broadcast and the like, so as to be implemented as an integrated multimedia player.

Efforts are ongoing to support and increase the functionality of mobile terminals. Such efforts include software and hardware improvements, as well as changes and improvements in the structural components.

Meanwhile, with a global introduction of 4G-LTE systems, limited frequency resources are occupied by each communication operator to supply services, and the frequency band is different for each communication operator.

Specifically, LTE-advanced abbreviated to LTE-A can provide faster data communication services by ensuring wide bandwidths or additional bands. Accordingly, communication operators are in competition to occupy wider and more frequency bands.

However, in a country with a broad area, it is difficult for a single operator to service all the regions of the nation by using its own base station. Thus, roaming services between operators are provided through the inter-operator agreement.

In addition, according to the trend that the whole world is integrated into one living zone, a roaming service in the form of World Phone is also needed.

As a result, it is necessary to consider the use of all of these various frequency bands in the design and manufacture of mobile communication terminals. However, in the case of a mobile communication terminal in which portability is emphasized, since the space for designing the antenna is continuously reduced for miniaturization, it is not easy to design the antenna to include all the wide frequency range.

### DISCLOSURE OF THE INVENTION

Therefore, an aspect of the present invention is to obviate those problems and other drawbacks. Another aspect of the detailed description is to minimize an input impedance difference between the lowest frequency and the highest frequency within a frequency range desired to control through a resonant frequency tunable technology.

Also, another aspect of the present invention is to maximize a variable frequency range by ensuring a physical length for varying a resonant frequency in a structural view of an antenna, and reduce a usage range of a component, such as an inductor to be used.

And, another aspect of the present invention is to realize an optical standing-wave ratio or the least reflection loss by ensuring a maximum bandwidth which can be implemented through an inverted-F type antenna within a given space.

To achieve these and other advantages and in accordance with the purpose of the present invention, as embodied and broadly described herein, there is provided a resonant frequency tunable antenna, including a first ground part, a feeding part (or power supply part) connected in a direction toward an antenna end from the first ground part, and a second ground part connected in a direction toward the antenna end from the feeding part, wherein the second ground part is a variable ground portion. The second ground part and the feeding part may be connected via a switch part, and the switch part may be connected to a grounded common port such that the second ground part and the feeding part are controlled in a cooperative manner.

The switch part may include at least two impedance elements, and a switch terminal portion configured to selectively connect the impedance elements to the common port.

The feeding part may be connected with a matching circuit for a frequency control. The impedance element may be an inductor or a capacitor.

A low resonant frequency may be realized as inductance is increased in case where the impedance element is the inductor, and a high resonant frequency may be realized as capacitance is decreased in case where the impedance element is the capacitor.

The first ground part may be connected with an impedance element having one side grounded. The switch part in a state of being connected to the feeding part may realize a lower resonant frequency than that in a state of being connected to the second ground part.

The impedance element connected to the switch part may include a feeding part connection element connected to the feeding part, and a ground part connection element connected to the second ground part. The feeding part connection element may be arranged to be connected to a front or rear side of the matching circuit connected to the feeding part.

The feeding part connection element may execute a shunt impedance adjusting function.

Also, in accordance with one embodiment disclosed herein, a resonant frequency tunable antenna may include a main ground part having a fixed impedance, a variable ground part electrically connected to the main ground part and having a changing impedance, a feeding part connected to the main ground part and the variable ground part to feed power to the main ground part and the variable ground part, and an impedance control circuit arranged between the feeding part and the variable ground part to control the impedance, wherein the impedance control circuit includes a feeding part connection element connected to the feeding part, a ground part connection element connected to the variable ground part, and a switch terminal portion configured to selectively operate the feeding part connection element or the ground part connection element, the switch terminal portion being connected to a grounded common port such that the variable ground part and the feeding part are controlled in a cooperative manner.

The feeding part may be arranged between the main ground part and the variable ground part, and one end portion of the main ground part or the variable ground part may be connected to an antenna end.

The main ground part and the variable ground part may be arranged adjacent to each other, and the feeding part may be connected to the main ground part or the variable ground part.

The main ground part and the variable ground part may be arranged between the feeding part and the antenna end. The feeding part may be connected in a direction toward the antenna end from the main ground part or the variable ground part.

A lower resonant frequency may be realized when the switch terminal portion operates the feeding part connection element, and a higher resonant frequency may be realized when the switch terminal portion operates the ground part connection element.

Each of the feeding part connection element and the ground part connection element may be provided by at least one. The feeding part may be connected with a matching circuit for a control of an input impedance, and the feeding part connection element may be arranged between the feeding part and the matching circuit.

The variable ground part may be provided by at least two, and the at least two variable ground parts may be selectively connected via a switch terminal disposed between the feeding part and the matching circuit and the respective impedance control circuits.

Changes in the impedance may be made by the feeding part connection element or the ground part connection element, and the feeding part connection element and the ground part connection element may be inductors or capacitors.

Also, in accordance with another embodiment disclosed herein, a mobile terminal having one of the resonant frequency tunable antennas may be provided.

### Advantageous Effect

A resonant frequency tunable antenna and a mobile terminal using the same according to the present invention will be described as follows.

According to at least one of embodiments disclosed herein, a communication system corresponding to more various resonant frequencies can be designed by extending a variable range of an antenna that varies the resonant frequency.

According to at least one of embodiments disclosed herein, since it is possible to optimize a return loss and a standing wave ratio (SWR) of a variable resonance frequency to a level that implements only a single resonant frequency in a given structure, it can be designed to achieve optimum antenna performance.

An additional range in which the present invention can be applied will become obvious in the following detailed description. However, various changes and modifications within the scope and range of the present invention can be clearly understood by those skilled in the other, and thus it should be understood that the detailed description and a specific embodiment such as the preferred embodiment of the present invention are merely illustrative.

### BRIEF DESCRIPTION OF THE DRAWINGS

FIG. 1 is a block diagram of a mobile terminal in accordance with the present invention.

FIG. 2A is a current distribution graph of an inverted-F type antenna.

FIG. 2B is a changing current distribution graph when an element such as an inductor is applied to change a resonant frequency.

FIG. 3 is a view of a basic structure capable of fabricating a resonant frequency tunable antenna using FIG. 2B.

FIG. 4 is an improved structural view to prevent a loss of an active element, such as a switch, from affecting the lowest frequency in variable frequencies.

FIG. 5 is a Smith's chart illustrating that inverted-F type antenna properties are changing into monopole antenna properties according to an added inductor.

FIG. 6A is a view for implementing two adjacent low resonant frequencies and two adjacent high resonant frequencies within a frequency range to be varied in accordance with one embodiment of the present invention.

FIG. 6B is a view illustrating only an operating part when a low resonant frequency within a variable frequency range operates.

FIG. 6C is a view illustrating only an operating part when a high resonant frequency within a variable frequency range operates.

FIG. 7 is a varied embodiment of FIG. 6, in which one low resonant frequency and three adjacent high resonant frequencies are implemented within a frequency range to be varied.

FIG. 8 is a view illustrating an affection of an element connected to a switch terminal when a low resonant frequency operates within a frequency range to be varied.

FIG. 9 is a view illustrating measurement results obtained by designing a resonant frequency tunable antenna using one embodiment of the present invention.

FIG. 10 is a view illustrating schematic systems of various resonant frequency tunable antennas in accordance with the present invention.

FIG. 11 is a view illustrating a schematic system of a resonant frequency tunable antenna in accordance with another embodiment of the present invention.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, laptop computers, digital broadcast terminals, personal digital assistants (PDAs), portable multimedia players (PMPs), navigators, slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, digital signage and the like.

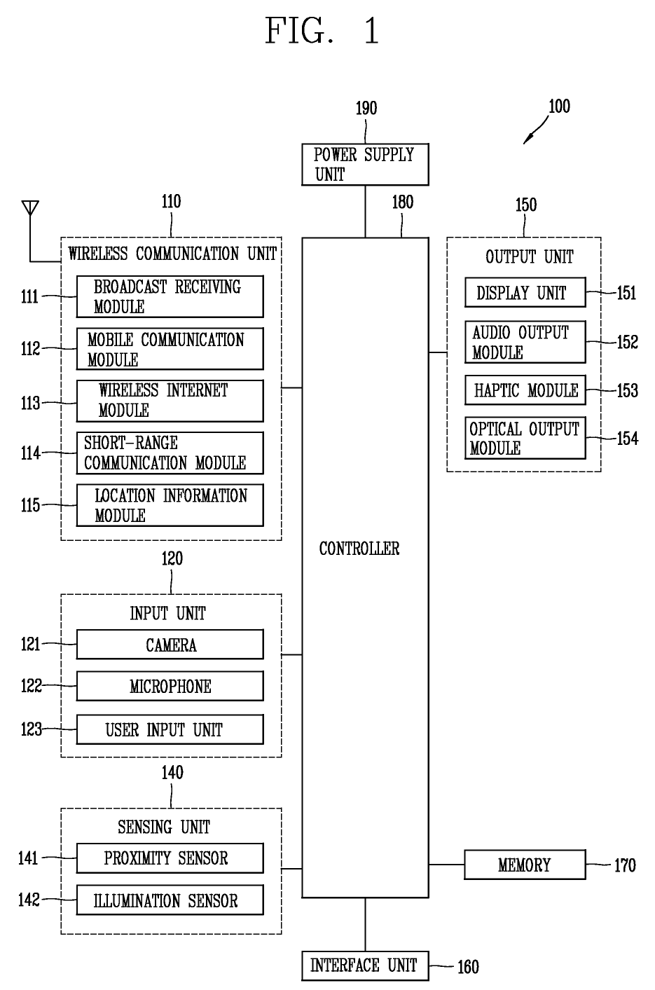

FIG. 1 is a block diagram of a mobile terminal in accordance with the present invention.

As illustrated in FIG. 1, The mobile terminal 100 may be shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 may typically include one or more modules which connect the mobile terminal 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 controls some or all of the components illustrated in FIG. 1A according to the execution of an application program that have been stored in the memory 170. In addition, the controller 180 may control at least two of those components included in the mobile terminal to activate the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Hereinafter, description will be given of embodiments of a resonant frequency tunable antenna capable of being implemented in the mobile terminal having the configuration, with reference to the accompanying drawings. It will be obvious to those skilled in the art that the present invention can be specified into other specific forms without departing from the scope and essential features of the present invention.

In recent time, with an increase in examples of using various resonant frequencies in a wide region, a resonant frequency switching (tuning) technology of an antenna, which can operate by changing a resonant frequency of an antenna according to a region where a mobile terminal is used or an operator's network is needed.

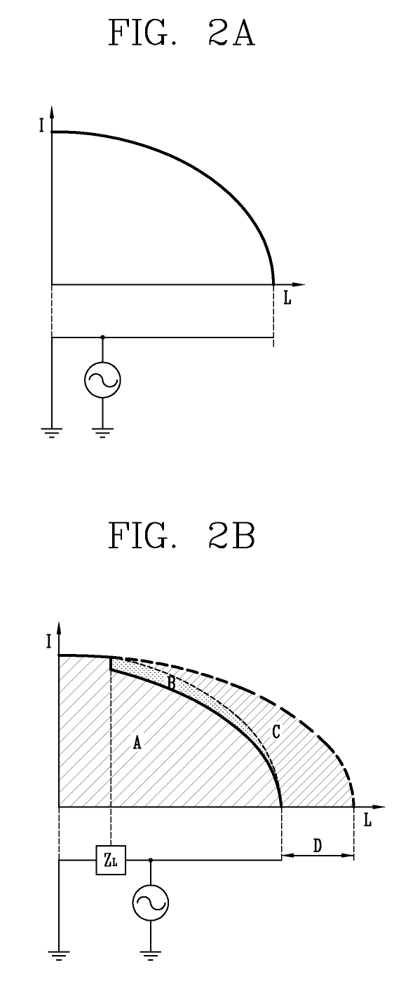

FIG. 2A is a current distribution graph of an inverted-F type antenna, and FIG. 2B is view illustrating a principle of implementing an inverted-F type antenna by representing a changing current distribution when an element such as an inductor is applied to change a resonant frequency.

In more detail, FIG. 2A is a graph showing a current distribution according to a length of a general inverted-F type antenna (IFA), and FIG. 2B illustrates a current distribution when an inductor ZL is added. As illustrated in FIGS. 2A and 2B, it can be noticed that an antenna length is reduced by D in response to the addition of the inductor ZL. That is, in order to install an antenna in a narrow space within the mobile terminal, it is necessary to use an inductor or a structure having inductance.

In order to switch (vary, tune) a resonant frequency of an antenna, as illustrated in FIG. 2, the inverted-F type antenna (IFA), which is categorized into a type of monopole antenna and is mainly used in a miniaturized device such as a mobile terminal, can employ a method of reducing the resonant length by applying the inductor ZL to slow a phase of a current near a start point of an antenna with high current distribution. Another method is to have high permittivity.

An initial amount of current distribution is A+B+C in FIG. 2B. On the other hand, an amount of the current distribution when only high permittivity is applied without using the element such as the inductor is A+B reduced by a volume of C. Also, when the impedance element such as the inductor is used, the amount of current distribution becomes A and thus the current distribution amount of B+C is reduced from the initial state.

As such, in the method using the impedance element such as the inductor, a resonant frequency can be shifted to a lower frequency when a value of the inductor used (Henry, H) is large. However, as the volume of the current distribution is overall reduced, a radiation performance is deteriorated in an inverse proportion to the size of the value of the used inductor. That is, when the inductor is used, the length of the antenna can be shortened (shortened by D in FIG. 2B). Accordingly, a reduced amount of the current distribution (B+C) due to the length reduction is greater than the reduced amount of the current distribution (C) upon simply applying the high permittivity, thereby more lowering the radiation performance than that upon applying the high permittivity. In this manner, when the inductor ZL is used, the length of the antenna can be reduced but the radiation performance is deteriorated due to the reduction of the current distribution.

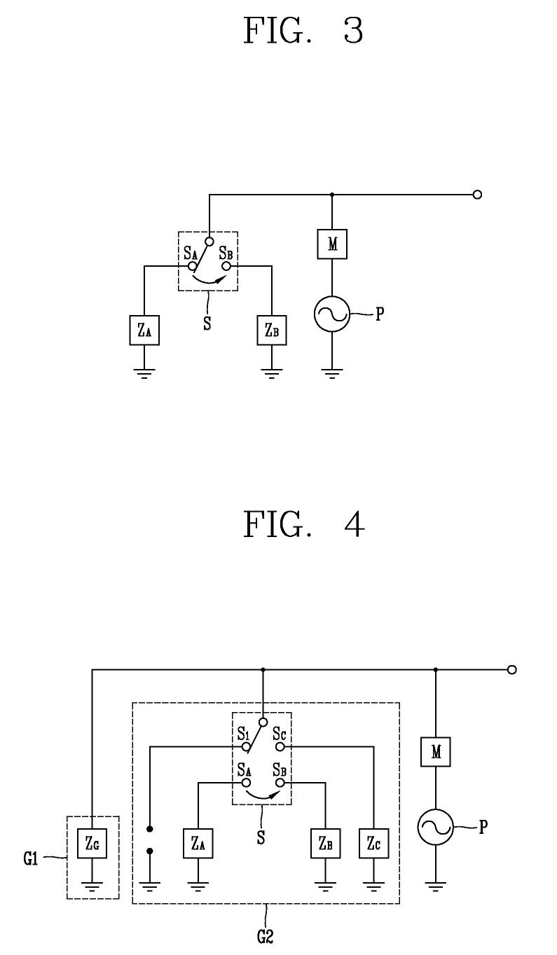

Meanwhile, FIG. 3 is a view of a basic structure capable of fabricating a resonant frequency tunable antenna using the principle illustrated in FIG. 2B. As illustrated in FIG. 3, when a current path of the antenna is varied by connecting it to switching terminals SA and SB using a switch S, a resonant length of the antenna can change according to changes in inductor values ZA and ZB used for the respective terminals SA and SB and the number of resonant frequency bands to be varied can also increase according to the number of the terminals of the switch. In this instance, M denotes a matching network and P denotes a power source in FIG. 3.

However, since the switch S is always involved in the operation of the antenna in this structure, a loss of the switch has an adverse effect on the performance of the antenna. Specifically, for a band corresponding to a relatively low frequency within a variable range, the worst performance among operated frequencies is exhibited, which results from an addition of a loss of a switching element as well as an increase in an antenna reduction rate due to the use of greater inductance and a thusly-caused deterioration of the radiation performance.

FIG. 4 is to solve the problem in FIG. 3, namely, an improved structural view to prevent a loss of an active element, such as a switch, from affecting the lowest frequency within variable frequencies. To overcome the problem caused in FIG. 3, a switch of a switch part S is connected to S1 terminal of FIG. 4 at the lowest frequency and thus is not involved in the operation of the antenna. That is, in FIG. 4, the antenna includes a first ground part G1, a second ground part G2 and a feeding part (feeder or power supply part) P. This is designed in a manner that inductors ZA, ZB and ZC operate only when a resonant frequency is varied to a higher frequency band.

In the switch part S of FIG. 4, when a switch is connected to S1 and thus the second ground part G2 is open, ZG as an impedance of the first ground part G1 operates. When the switch is connected to SA so as to be connected to ZA, a shunt inductance of ZG and ZA operates.

Also, similarly in case of using additional inductors such as ZB and ZC, a shunt inductance of ZG and ZB or ZG and ZC operates. In this instance, when an inductor value of ZB is greater than that of ZC, ZC is allowed to have 0 Ohm (Ω) or capacitance so as to change the shunt impedance to ZG to be small. Accordingly, it may be configured to resonate at increasingly higher frequencies. M denotes a matching network and P denotes a power source in FIG. 4.

However, those methods illustrated in FIGS. 3 and 4 use inductors all arranged in a direction of a ground of an antenna. Accordingly, when a variable range of frequencies should be broadly designed, a problem that the shunt impedance viewed from the power source P as a feeding end of the antenna increases toward lower frequencies.

As illustrated in FIG. 3, the resonant frequency variable antenna capable of defining the operating principle maximizes the inductance of the ground portion (part), thereby realizing the lowest frequency among the variable resonant frequencies. However, in this instance, the shunt impedance of an input impedance of the antenna increases and an impedance bandwidth decreases accordingly. This is shown in a shape that an impedance locus (approximately circular shape) increases in size in the Smith's Chart.

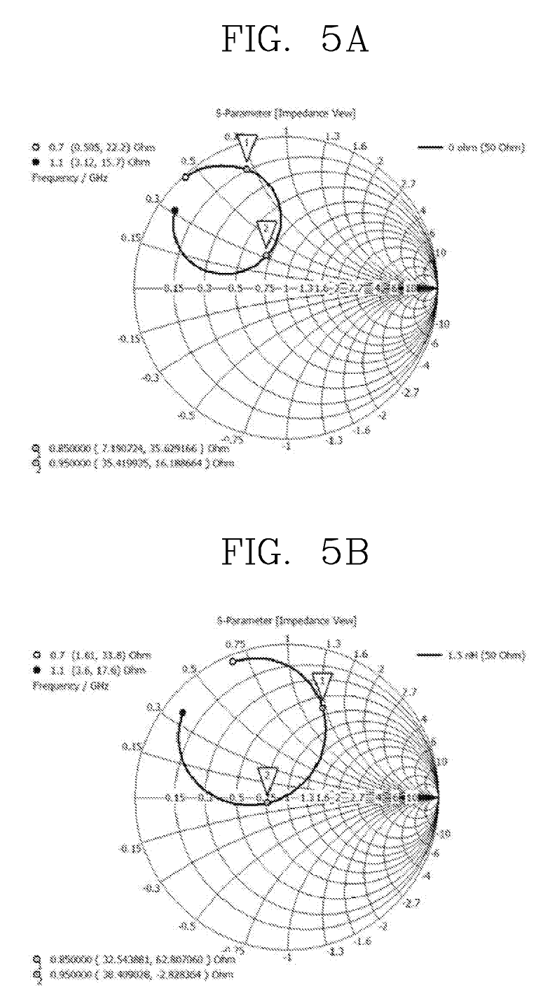

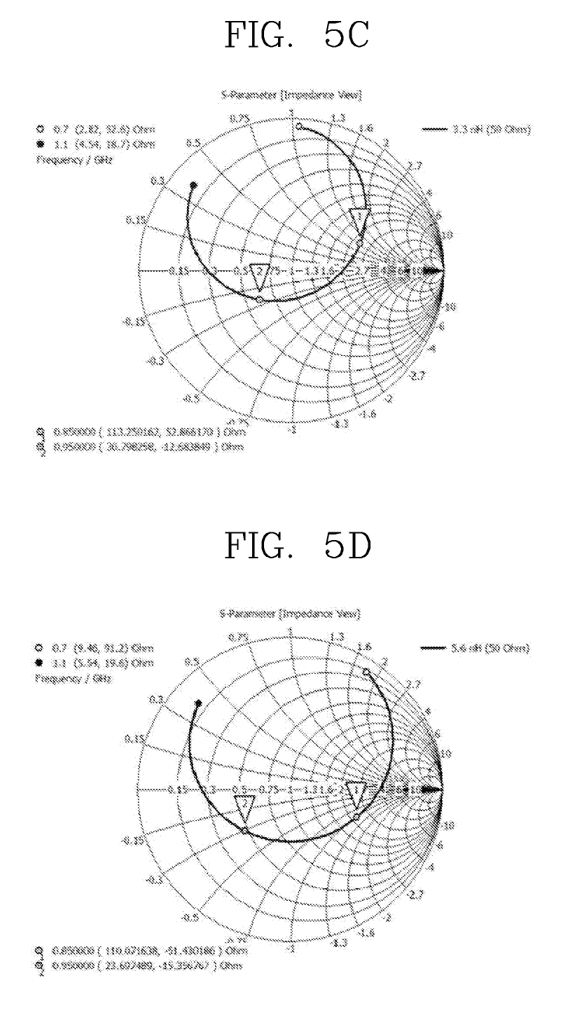

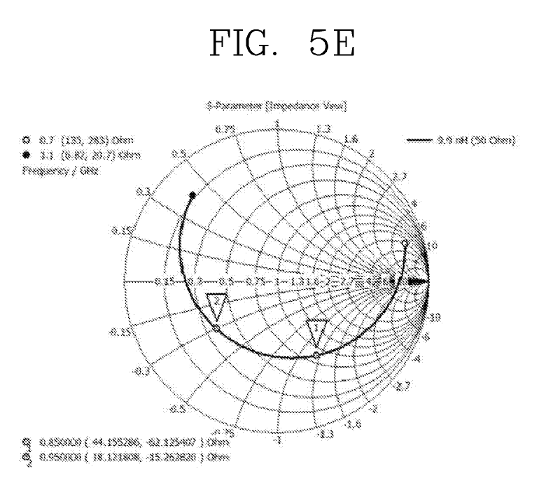

As illustrated in FIG. 5, the advantages of the inverted-F type antenna in terms of the bandwidth become similar to the properties of the monopole antenna, which results in deterioration the antenna properties.

FIG. 5 illustrates measurement results resulting from that the inverted-F type antenna changes into the properties of the monopole antenna according to an added inductor, which illustrates the changes in the input inductance in the Smith's chart, in response to the increase in the inductance of the ground part. That is, FIG. 5 illustrates an increased state of the inductance from FIG. 5A towards FIG. 5E.

FIGS. 5A to 5E illustrate the changes of the properties which have arisen the development of the inverted-F type antenna because it is difficult to implement sufficient bandwidths using the monopole antenna in a reduced antenna space in a miniaturized mobile terminal. If the graph of FIG. 5A is defined as the properties of the inverted-F type antenna, the properties of the inverted-F type antenna are defined as the properties of the monopole antenna as going to FIG. 5E.

If a greater inductor is used in order to implement a low frequency within the variable resonant frequency range, the inverted-F type antenna gradually exhibits the monopole antenna properties and thus the bandwidth of the antenna is reduced.

Therefore, the resonant frequency tunable antenna with the structure as illustrated in FIG. 4 is limited due to an impedance difference between a resonant frequency with the lowest resonant frequency tunable range and a resonant frequency with the highest resonant frequency tunable range.

In case of a terminal designed to be compact like as a mobile terminal, since the monopole antenna is merely implemented adjacent to a ground surface and thus exhibits a narrow band characteristic, a boundary condition is forcibly created by connecting one side of the antenna to the ground surface, and the inverted-F type antenna which implements a bandwidth using a parallel inductance generated in the boundary condition is usually used.

Therefore, the increase in the shunt impedance viewed from the feeding end brings about the loss of the advantages of the inverted-F type antenna and causes the input impedance difference in terms of the resonance characteristic of the lowest frequency and the highest frequency within the variable range. Accordingly, it is difficult to design the antenna to have the same and optimal standing wave ratio (SWR) or return loss.

Therefore, one embodiment according to the present invention provides an antenna switch for minimizing a voltage SWR (VSWR) or the return loss. Hereinafter, this will be described.

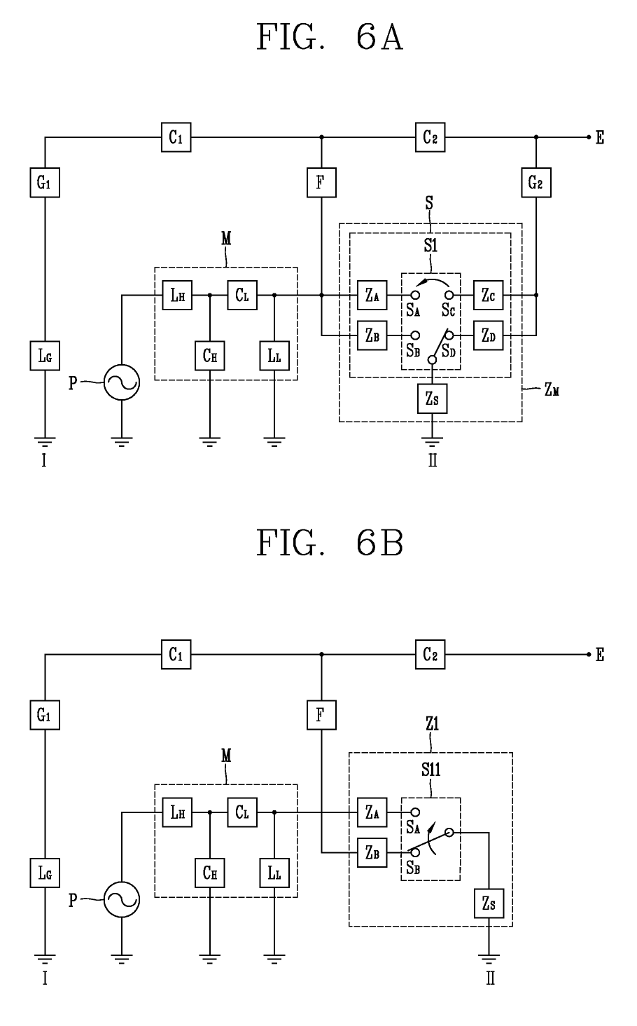

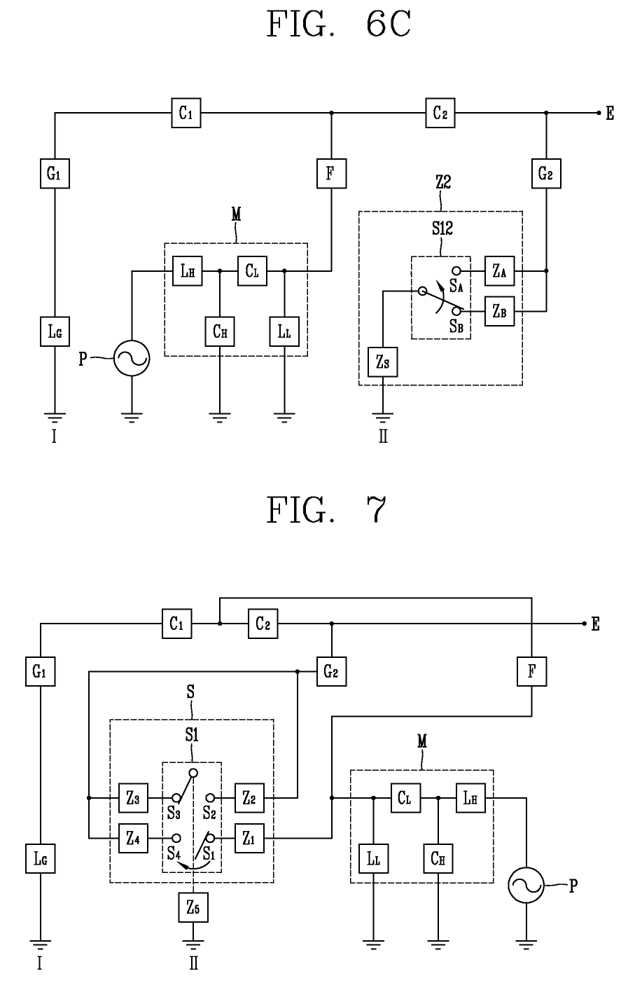

FIG. 6A is a view for implementing two adjacent low resonant frequencies and two adjacent high resonant frequencies within a frequency range to be varied in accordance with one embodiment of the present invention, FIG. 6B is a view illustrating only an operating part when a low resonant frequency within a variable frequency range operates, and FIG. 6C is a view illustrating only an operating part when a high resonant frequency within a variable frequency range operates.

As illustrated in FIG. 6A, a resonant frequency tunable antenna according to one embodiment disclosed herein includes a first ground part G1, a feeding part F connected in a direction from the first ground part G1 toward an antenna end E, and a second ground part G2 connected in a direction from the feeding part F toward the antenna end E. In this instance, the second ground part G2 is a variable ground portion. The second ground part G2 and the feeding part F are connected by the switch part S. The switch part S is grounded by a common port (or common terminal) ZS such that the second ground part G2 and the feeding part F are cooperatively controlled.

In this instance, the first ground part G1 as a main ground portion has a fixed impedance, and the second ground part G2 as a variable ground portion has an impedance varied by the switch part S.

That is, in the one embodiment disclosed herein, the inverted-F type antenna (IFA) basically having the main ground part G1 and at least one variable ground part G2 applies an impedance element (or lumped element LG), like the inductor ZL of FIG. 2, to the first ground part G1 to use a current phase delay. In this instance, the switch part S includes at least two impedance elements ZA, ZB, ZC and ZD, and a switch terminal portion S1 for selectively connecting the impedance elements ZA, ZB, ZC and ZD to a common port ZS.

Since the value of the second ground part G2 should change to realize a desired resonant frequency, the switch terminal portion S1 is applied. The switch terminal portion S1 may have a different number of terminals according to a number of resonant frequencies to be varied. FIG. 6A illustrates four impedance elements, but the present invention may not be necessarily limited to this. The number of impedance elements may change according to an increase or decrease of the number of resonant frequencies.

A shunt impedance value of the first ground part G1 and the second ground part G2 when viewed from the feeding part F decides an impedance of an entire ground portion of the antenna, and this decides the resonant frequency of the antenna. Therefore, the value can be configured from an infinite impedance state in which the switch of the second ground part G2 is turned off, which is a condition allowing an operation of only the first ground part G1, to a combination of various shunt impedances using an inductor and a capacitor. In this instance, the impedance elements ZA, ZB, ZC, ZD may be the inductors or capacitors. When the impedance elements ZA, ZB, ZC, ZD are the inductors, a lower resonant frequency may be realized as an inductance is higher. On the other hand, when the impedance elements ZA, ZB, ZC, ZD are the capacitors, a higher resonant frequency may be realized as a capacitance is lowered.

That is, the impedance element connected to the second ground part G2 can be configured as various elements, such as the inductor, the capacitor or the like, which have reactance values without a loss, from an OFF state of, namely, a terminal open state (a state that ZA and ZB are connected by the switch terminal portion S1). However, the following description will be given under assumption that the impedance element is the inductor.

The method of changing the resonance by applying the impedance such as the inductor to the ground part in the inverted-F type antenna, as illustrated in FIG. 2, does not have to construct the ground part by dividing, as illustrated in FIG. 3, into the main (fixed) ground part G1 and the variable ground part G2. However, according to one embodiment disclosed herein, the ground part should be constructed by dividing into the main (fixed) ground part G1 and the variable ground part G2 to enable the cooperation of the switch terminal portion S1 and the feeding part F.

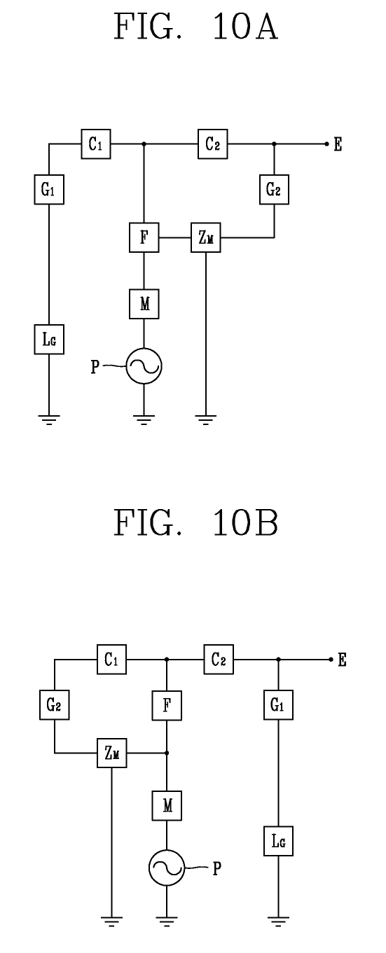

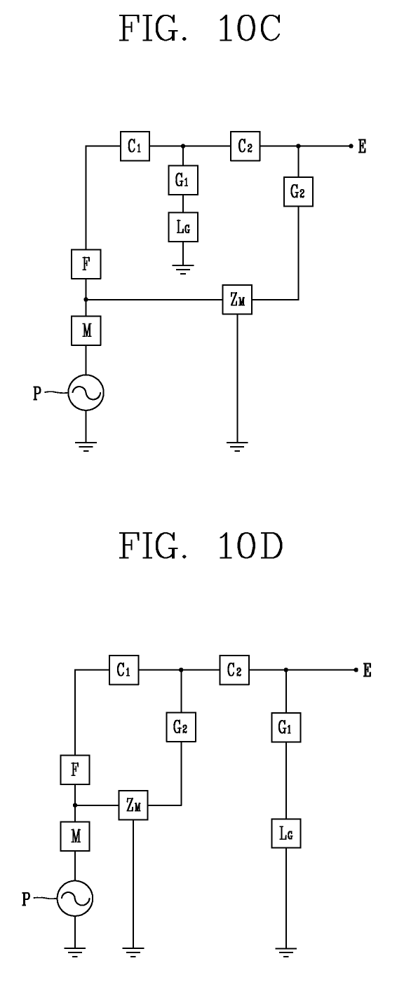

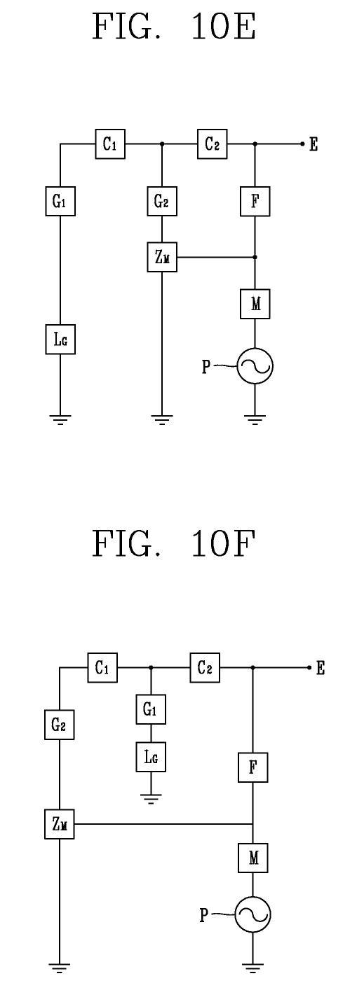

Also, in one embodiment disclosed herein, the feeding part F and the second ground part G2 as the variable ground portion are arranged in the order of being connected to the antenna based on a proceeding direction from the first ground part G1 toward the antenna end E. However, this is for maximizing the variable range of the resonant frequencies. Therefore, those components may be arranged in the order of the first ground part G1, the second ground part G2, the feeding part F and the antenna end E, or in the order of the feeding part F, the first ground part G1, the second ground part G2 and the antenna end E. This will be described later with reference to FIG. 10.

In this instance, the second ground part G2 is connected to at least two of the impedance elements ZA, ZB, ZC and ZD, and the impedance elements ZA, ZB, ZC and ZD are selectively connected by the switch terminal portion S1. Here, the impedance elements ZA, ZB, ZC and ZD may be the inductors or capacitors. Hereinafter, description will be given under assumption that the impedance element is the inductor.

The switch terminal portion S1 is disposed between the second ground part G2 and a ground surface II and the common port ZS is connected to the ground surface II. This is for allowing the second ground part G2 and the feeding part F to share the single surface II.

A necessary number of switch terminals among the four switch terminals SA, SB, SC and SD are connected to the second ground part G2 according to a number of high frequency bands among the resonant frequencies desired to be varied.

In this instance, at least one low resonant frequency may be used. FIG. 6A illustrates an embodiment having four variable resonant frequencies including two adjacent low resonant frequencies and two adjacent high resonant frequencies. FIG. 7 illustrates an embodiment having four variable resonant frequencies including one low resonant frequency and three adjacent high resonant frequencies. However, these are merely illustrative, and alternatively three adjacent low resonant frequencies and one high resonant frequency can be used. In addition, at least five resonant frequencies can be implemented by using at least five impedance elements, if necessary.

Meanwhile, in one embodiment disclosed herein, a matching circuit M is connected to the feeding part F. This is for controlling each of the adjacent high or low frequencies. The matching circuit M of the feeding part F, as illustrated in FIG. 6A, includes a parallel inductor LL, a series capacitor CL, a parallel capacitor CH and a series inductor LH, to control each of low and high frequencies at an operated frequency.

In this instance, the parallel inductor LL and the series capacitor CL are used to match low frequencies and the parallel capacitor CH and the series inductor LH are used to match high frequencies.

Switch terminals SA and SB for controlling impedances of low frequencies among the variable frequencies are connected between the impedance matching circuit M and the feeding part F. That is, the impedance elements ZA, ZB, ZC and ZD include the feeding part connection elements ZA and ZB connected to the feeding part F and the ground part connection elements ZC and ZD connected to the second ground part G2. The feeding part connection elements ZA and ZB are arranged between the feeding part F and the matching circuit M. In more detail, the feeding part connection elements ZA and ZB are arranged to be connected to the front or rear of the matching circuit M connected to the feeding part F.

In this instance, the feeding part connection elements ZA and ZB execute a shunt impedance adjusting function.

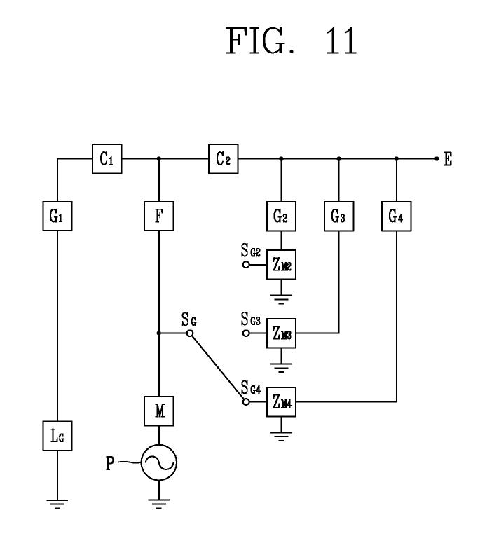

To increase the number of resonant frequencies to be varied, the switch terminal portion S1 used in the embodiments of FIG. 6 and FIG. 7 is replaced with a switch terminal portion with at least four switch terminals. Also, a better effect is obtained by increasing the number of the second ground part G2 as the variable ground portion, such as an addition of G2, G4 and the like. That is, according to one embodiment of the present invention, the number of the second ground part G2 as the variable ground portion may be at least two. This will be explained later with reference to FIG. 11.

And, the resonant frequency tunable antenna according to the one embodiment disclosed herein includes a first controller C1 that is arranged between the first ground part G1 and the feeding part F to control a resonant frequency tunable range through a length control, and a second controller C2 that is arranged between the feeding part F and the second ground part G2 to control an impedance and the resonant frequency tunable range through the length control.

FIG. 6B separately illustrates an actually-driven portion in FIG. 6A when a low resonant frequency of the resonant frequencies to be varied is operating, and FIG. 6C separately illustrates an actually-driven portion in FIG. 6A when a high resonant frequency of the resonant frequencies to be varied is operating.

Referring to FIG. 6B, in order to use adjacent low resonant frequencies, the two impedance elements ZA and ZB have been arranged to be connected by the switch terminals SA and SB of the first switch terminal portion S11, respectively. In this instance, in the state that the inductor values are ZA>ZB, ZA and LL within the impedance matching circuit M connected to the feeding part F implement a shunt impedance LL∥ZA therebetween when ZA is connected, whereas ZB and LL within the impedance matching circuit M connected to the feeding part F implement a shunt impedance LL∥ZB therebetween when ZB is connected, thereby implementing adjacent resonant frequencies. That is, the monopole antenna properties is improved to the inverted-F type antenna properties at the low resonant frequency by a first impedance circuit Z1 which includes the impedance elements ZA and ZB, the switch terminals SA and SB and the common port ZS, thereby realizing an optimal return loss.

Meanwhile, referring to FIG. 6C, in order to use adjacent low resonant frequencies, the two impedance elements ZC and ZD have been arranged to be connected by the switch terminals SC and SD of a second switch terminal portion S12, respectively. In this instance, in the state that the inductor values are ZC>ZD, ZC and the first ground part G1 implement a shunt impedance G1∥ZC therebetween when ZC is connected, whereas ZD and the first ground part G1 implement a shunt impedance G1∥ZD therebetween when ZD is connected, thereby implementing adjacent resonant frequencies. That is, the high resonant frequencies can be realized by a second impedance circuit Z2 which includes the impedance elements ZC and ZD, the switch terminals SC and SD and the common port ZS.

In this instance, the inductor values of the impedance elements have the relationship of LG>(LG∥(ZC+ZS))>(LG∥(ZD+ZS)).

Accordingly, the adjacent high resonant frequencies and the adjacent low resonant frequencies can be realized.

Meanwhile, FIG. 7 is a varied embodiment of FIG. 6, which illustrates an embodiment for implementing one low resonant frequency and three adjacent high resonant frequencies within a frequency range to be varied. Referring to FIG. 7, the first ground part G1, the feeding part F and the second ground part G2 are sequentially arranged toward the antenna end E and four resonant frequencies can additionally be realized by four impedance elements Z1, Z2, Z3 and Z4. For example, one low resonant frequency can be realized by the impedance element Z1 and three adjacent high resonant frequencies can be realized by the three impedance elements Z2, Z3 and Z4.

As such, the resonant frequency tunable antenna allowing the cooperative control of the ground parts and the feeding part can constantly maintain the impedance of the lowest resonant frequency and the highest resonant frequency within the variable frequency range, and thus the variable range can be maximized.

To design the cooperative control structure of the ground part G2 and the feeding part F as illustrated in FIG. 6, after constructing the main ground part G1 and the variable ground part G2, the impedance element ZA connected through the switch terminal SA, which is configured to operate only the main ground part G1, among the switch terminals SA, SB, SC and SD of the switch terminal portion S1, is constructed. The impedance element is arranged between the feeding part F and the impedance matching circuit M. The impedance element ZA is configured to realize the lowest resonant frequency within the variable frequency range.

As an element value of the impedance element ZA, a low impedance value is applied to offset high impedance for implementing a low resonant frequency which is used in the ground part of the inverted-F type antenna.

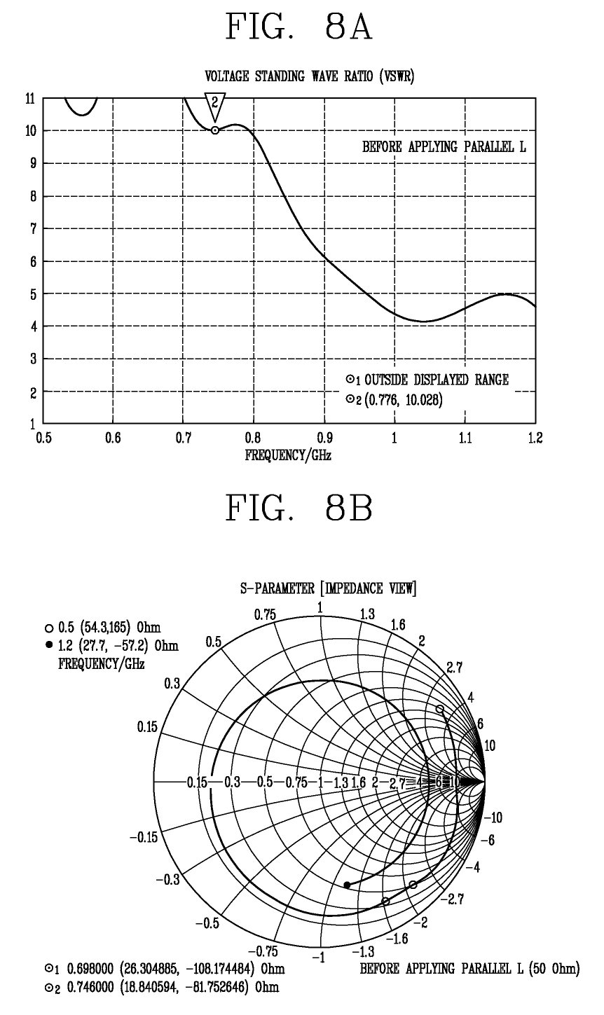

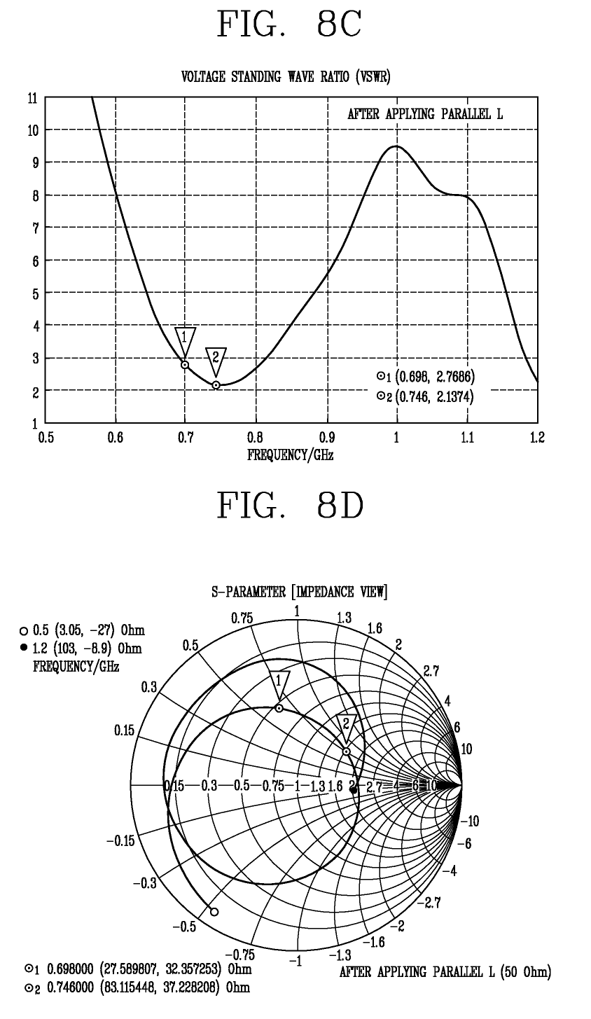

For example, if an inductor value of about 5.6 nH is used for the impedance element LG of the first ground part G1 and the impedance element ZA is not used, the input impedance characteristics as illustrated in FIGS. 8A and 8B are obtained accordingly. However, the great shunt inductance is offset by connecting an impedance matching element, such as 10 nH, to the impedance element ZA of the variable ground part G2. Thus, the input impedance and the resonance characteristics as illustrated in FIGS. 8C and 8D can be implemented.

That is, the first ground part G1 uses an impedance element with a relative great value for implementing the lowest frequency as the resonant frequency. This changes the antenna properties to be close to the monopole antenna properties as illustrated in FIGS. 8A and 8B. Therefore, it is difficult to match impedances to have a good return loss characteristic, due to a very lack of bandwidth or a too great circular locus of the input impedance within most of the narrow antenna space.

To overcome this, the impedance element ZA connected to the feeding part F among those components of the switch part S is used. The impedance element ZA serves to control the shunt impedance at the feeding part F. Therefore, by use of the element having the characteristic of reducing the shunt impedance, the antenna properties changed due to the great impedance element connected to the first ground part G1 is restored back to the inverted-F type antenna properties, as illustrated in FIGS. 8C and 8D.

Afterwards, through the calculation of the shunt impedance of the first ground part G1 and the second ground part G2, the element ZD connected to the second ground part G2 for implementing the highest resonant frequency is decided while the antenna, the matching circuit M and the element LG of the first ground part G1 which are the same as those when implementing the lowest resonant frequency are maintained.

Typically, the element ZD connected to the second ground part G2 is configured to have a capacitance at 0 Ohm to provide the most efficient value.

Adequate values of the elements ZB and ZC for forming intermediate resonant frequencies may be decided through experiments.

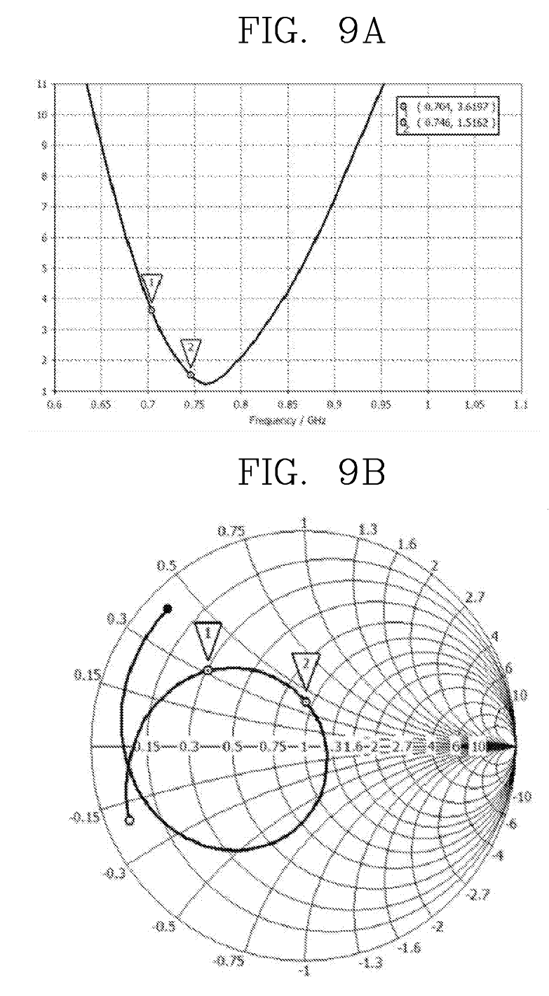

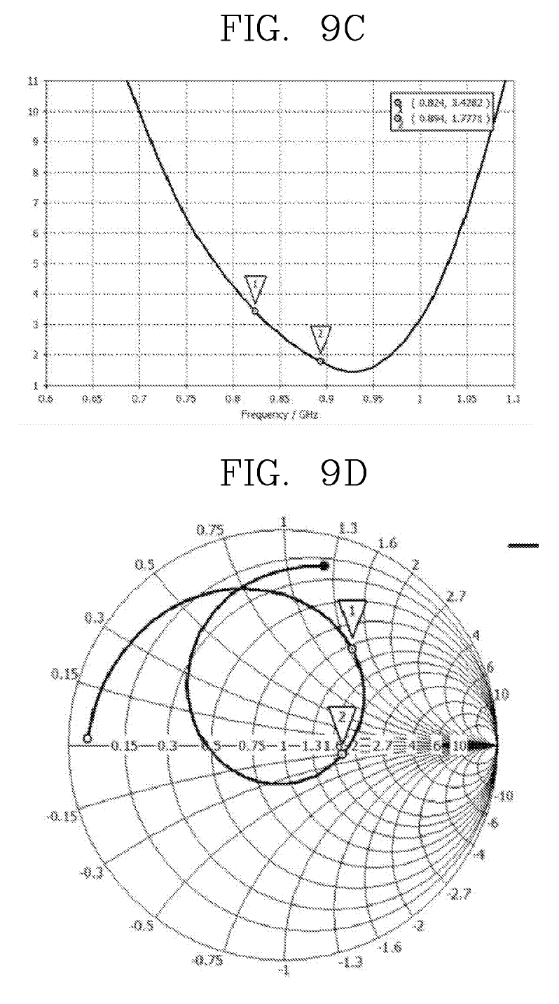

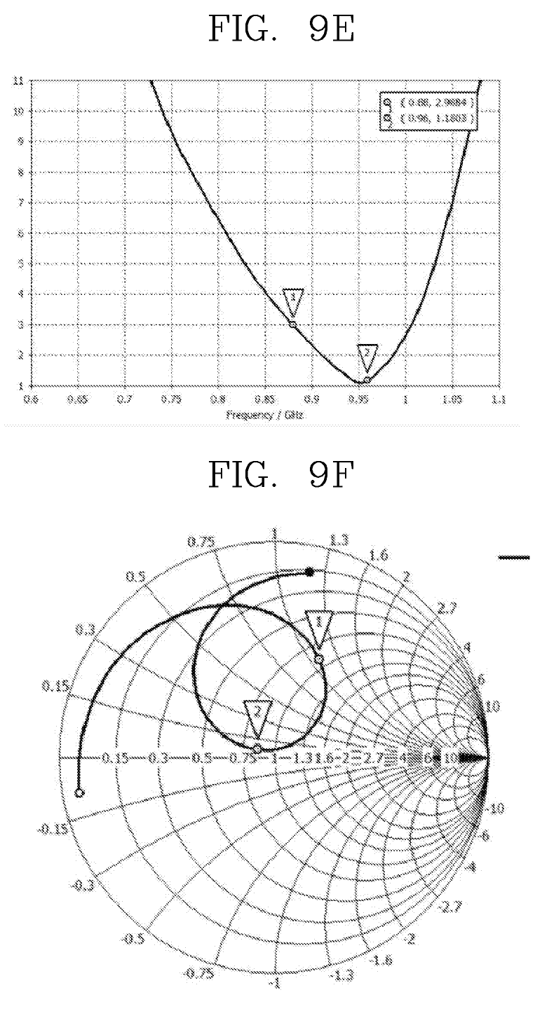

FIG. 8 illustrates the affection of an element connected by a switch terminal when a low resonant frequency operates within a frequency range to be varied in accordance with one embodiment of the present invention, and FIG. 9 is a view illustrating measurement results obtained by designing a resonant frequency tunable antenna in accordance with one embodiment of the present invention.

In more detail, FIGS. 8A and 8B illustrate changes in a voltage standing wave ratio (VSWR) according to changes in an impedance before applying the parallel inductors ZA and ZB and FIGS. 8C and 8D illustrate the changes in the voltage standing wave ratio according to the changes in the impedance after applying the parallel inductors ZA and ZB. FIG. 8 illustrates an embodiment which illustrates the changes in the VSWR according to a frequency change resulting from an operation or non-operation of elements (ZA and ZB of FIG. 6, Z1 of FIG. 7) connected to the switch terminal illustrated in FIGS. 6B and 7.

FIG. 9 exemplarily illustrates a measurement value obtained by varying the resonant frequency using such a method. FIGS. 9A to 9F illustrate structures of varying three resonant frequencies. FIGS. 9A and 9B illustrate a resonance shift to 698˜746 MHz for LTE B17, FIGS. 9C and 9D illustrate a resonance shift to 824˜894 MHz for LTE B5, and FIGS. 9E and 9F illustrate a resonance shift to 880˜960 MHz for LTE B8.

A size of a circular locus of an input impedance in each resonant state is maintained in an almost similar level, which can be controlled by the impedance elements ZA, ZB, ZC and ZD connected to the feeding part F in the switch part S illustrated in FIGS. 6 and 7.

That is, the impedance elements ZC and ZD connected to the variable ground part G2 in the switch part S tune the resonant frequencies of the antenna, but accordingly the shunt impedance of the antenna is decided to be different for each resonant frequency. In most cases, the greatest impedance is observed when only the first ground part G1 operates. This is calibrated by the elements ZA and ZB connected to the feeding part F in the switch part S, thereby reducing the difference of the input impedance for each resonant frequency.

Such impedance calibration principle is described in FIG. 8.

Referring to FIGS. 9A to 9F, all of the resonance properties of the antenna set toward a slightly high frequency within the frequency band by considering an affection to a human body have optimal matching characteristics. This may result in exhibiting an optimized return loss.

The aforementioned structures illustrated in FIGS. 6 and 7 show a difference in construction of the terminals of the switch connected to the variable ground point. FIG. 6 illustrates a circuit for constructing four resonant frequencies because four terminals are employed for the switch, which is an adequate configuration when two resonant frequencies are oriented toward a lower side and two resonant frequencies are oriented toward a higher side.

FIG. 7 illustrates an adequate configuration with four resonant frequencies including one low resonant frequency and three high resonant frequencies. That is, the connection of the used terminals of the switch to the variable ground part G2 is for implementing a relatively high resonant frequency within the variable frequency range, and the connection to the feeding part F is for implementing a relatively low resonant frequency.

The resonant frequency tunable antenna in one embodiment of the present invention has the configuration of ‘the main ground part G1, the feeding part F, the variable ground part G2 and the antenna end E.’ This is to control the resonant frequencies merely according to the impedance change of the ground part and also more extend the resonant frequency variable range additionally using a difference of the resonant frequency resulting from a length difference between the main ground part G1 and the variable ground part G2.

According to the element value (inductance or capacitance) connected to the switch terminal portion S1, the impedance difference between the main ground part G1 and the variable ground part G2 viewed from the feeding part F changes. When a relatively low frequency is implemented, the impedance of the main ground part G1 is smaller than the impedance of the variable ground part G2, and thus most of standing waves are generated along a ground surface I of the main ground part G1. On the other hand, when a relatively high frequency is implemented, the impedance of the variable ground part G2 is smaller than the impedance of the main ground part G1, more current standing waves are generated along a ground surface II of the variable ground part G2.

Accordingly, a current start point of the antenna may actually be assumed as the ground surface I of the main ground part G1 at the lowest resonant frequency and the ground surface II of the variable ground part G2 at the highest resonant frequency. Therefore, the physical length difference of the antenna as well as the change amount of the impedance of the ground part of the inverted-F type antenna is used as means for tuning resonance.

However, when using such the physical length difference, the input impedance difference between the lowest frequency and the highest frequency within the variable range becomes more severe, and thereby the variable range is difficult to be used unless employing the structure of cooperating with the feeding part as illustrated in the present invention.

The structure of the resonant frequency tunable antenna according to one embodiment of the present invention may not be easy to have the sequential arrangement of ‘main ground part G1, feeding part F, variable ground part G2 and antenna end E.’ A structure with an arrangement of ‘main ground part G1, variable ground part G2, feeding part F and antenna end E’ or an arrangement of ‘feeding part F, main ground part G1, variable ground part G2 and antenna end E’ may alternatively be employed.

A standard for determining the arrangement of each part G1, G2, F can be known by checking that each intersecting portion is connected with going backward from the antenna end E. In this manner, when the number of switch terminals and impedance elements used increases, and even when the number of the variable ground points increases, operations can be distinguishably understood based on the same principle. Even in this case, the impedance element for implementing the low resonant frequency should be arranged between the feeding part F and the matching circuit M.

FIG. 10 illustrates a schematic system of various resonant frequency tunable antennas according to the present invention. FIGS. 10A and 10B illustrate a configuration that the feeding part F is arranged between the main ground part G1 and the variable ground part G2 and one end portion of the main ground part G1 or the variable ground part G2 is connected to the antenna end E. FIGS. 10A and 10B illustrate a structure with a sequential arrangement of ‘main ground part G1, feeding part F, variable ground part G2 and antenna end E’ and a sequential arrangement of ‘variable ground part G2, feeding part F, main ground part G1 and antenna end E,’ respectively.

In another embodiment, the main ground part G1 and the variable ground part G2 are arranged adjacent to each other, and the feeding part F is connected to the main ground part G1 or the variable ground part G2. In this instance, the main ground part G1 and the variable ground part G2 may be arranged between the feeding part F and the antenna end E or the feeding part F may alternatively be connected in a direction from the main ground part G1 or the variable ground part G2 toward the antenna end E.

For example, FIGS. 10C and 10D illustrate the structure in which the main ground part G1 and the variable ground part G2 are arranged adjacent to each other, the feeding part F is connected to the main ground part G1 or the variable ground part G2, and the feeding part F is arranged far away from the antenna end E. That is, FIG. 10C illustrates an antenna with the components arranged in sequence of ‘feeding part F, main ground part G1, variable ground part G2 and antenna end E,’ and FIG. 10D illustrates an antenna with the components arranged in sequence of ‘feeding part F, variable ground part G2, main ground part G1 and antenna end E.’

Also, FIGS. 10E and 10F illustrate structures in which the main ground part G1 and the variable ground part G2 are arranged adjacent to each other, the feeding part F is connected to the main ground part G1 or the variable ground part G2, and the feeding part F is connected to the antenna end E. That is, FIG. 10E illustrates an antenna with the components arranged in sequence of ‘main ground part G1, variable ground part G2, feeding part F and antenna end E’ and FIG. 10F illustrates an antenna with the components arranged in sequence of ‘variable ground part G2, main ground part G1, feeding part F and antenna end E.’

In this instance, ZM illustrated in FIGS. 10A to 10F denotes an impedance control circuit and may be the same as ZM in FIG. 6A. M is the same as the matching circuit in FIG. 6A.

FIG. 11 illustrates a schematic system of a resonant frequency tunable antenna in accordance with another embodiment of the present invention, which schematically illustrates an antenna when employing a plurality of variable ground parts.

Referring to FIG. 11, the first ground part G1 as the main ground part with a fixed impedance, the feeding part F, the matching circuit M and the second ground part G2 are the same as those in FIG. 6A, and a second impedance control circuit ZM2 indicates the same as the ZM in FIG. 6A. That is, in addition to those components illustrated in FIG. 6A, a third ground part G3 and a fourth ground part G4 as variable ground parts, and third and fourth impedance matching circuits ZM3 and ZM4 for varying impedances are additionally employed. In this instance, the second to fourth impedance matching circuits ZM2, ZM3 and ZM4 are different from one another, and selectively connected via one of switch terminals SG2, SG3 and SG4 of the switch terminal portion SG. In this instance, the switch terminal SG is arranged between the feeding part F and the matching circuit M.

Here, impedance elements as components of the second to fourth impedance control circuits ZM2, ZM3 and ZM4 are differently arranged to make impedances of the second to fourth ground parts G2, G3 and G4 different from one another. The impedance elements of the second to fourth impedance control circuits ZM2, ZM3 and ZM4 may differ according to the range and number of resonant frequencies to be varied. They have similar configurations to the impedance elements ZA, ZB, ZC and ZD illustrated in FIG. 6, so detailed description thereof will be omitted.

Accordingly, the shunt impedance is varied by the second to fourth impedance control circuits ZM2, ZM3 and ZM4 connected to the second to fourth ground parts G2, G3 and G4, thereby implementing various resonant frequencies.

Also, a mobile terminal having the aforementioned resonant frequency tunable antenna may be provided in accordance with one embodiment of the present invention. The resonant frequency tunable antenna may be disposed within the mobile terminal or arranged on a rear or front surface of the mobile terminal. A position of the resonant frequency tunable antenna may not be specifically limited.

The foregoing description should not be limitedly construed in all aspects but considered as merely illustrative. The scope or range of the present invention should be decided by a rational interpretation of the appended claims. All changes and modifications made within an equivalent range of the present invention are embraced by the appended claims of the present invention.

### INDUSTRIAL AVAILABILITY

Those embodiments of the present invention can be applied to an antenna for varying a resonant frequency by a cooperative control of a ground part and a feeding part.

1. A resonant frequency tunable antenna, comprising:
a first ground part;
a feeding part connected in a direction toward an antenna end from the first ground part; and
a second ground part connected in a direction toward the antenna end from the feeding part,
wherein the second ground part is a variable ground portion, and
wherein the second ground part and the feeding part are connected via a switch part, and the switch part is connected to a grounded common port such that the second ground part and the feeding part are controlled in a cooperative manner.

2. The antenna of claim 1, wherein the switch part comprises:
at least two impedance elements; and
a switch terminal portion configured to selectively connect the impedance elements to the common port.

3. The antenna of claim 2, wherein the feeding part is connected with a matching circuit for a frequency control.

4. The antenna of claim 2, wherein the impedance element is an inductor or a capacitor.

5. The antenna of claim 4, wherein a low resonant frequency is realized as inductance is increased in case where the impedance element is the inductor, and a high resonant frequency is realized as capacitance is decreased in case where the impedance element is the capacitor.

6. The antenna of claim 2, wherein the first ground part is connected with an impedance element having one side grounded.

7. The antenna of claim 6, wherein the switch part in a state of being connected to the feeding part realizes a lower resonant frequency than that in a state of being connected to the second ground part.

8. The antenna of claim 7, wherein the impedance element connected to the switch part comprises a feeding part connection element connected to the feeding part, and a ground part connection element connected to the second ground part.

9. The antenna of claim 8, wherein the feeding part connection element is arranged to be connected to a front or rear side of the matching circuit connected to the feeding part.

10. The antenna of claim 8, wherein the feeding part connection element executes a shunt impedance adjusting function.

11. A resonant frequency tunable antenna, comprising:
a main ground part having a fixed impedance;
a variable ground part electrically connected to the main ground part and having a changing impedance;
a feeding part connected to the main ground part and the variable ground part to feed power to the main ground part and the variable ground part; and
an impedance control circuit arranged between the feeding part and the variable ground part to control the impedance,
wherein the impedance control circuit comprises:
a feeding part connection element connected to the feeding part;
a ground part connection element connected to the variable ground part; and
a switch terminal portion configured to selectively operate the feeding part connection element or the ground part connection element, the switch terminal portion being connected to a grounded common port such that the variable ground part and the feeding part are controlled in a cooperative manner.

12. The antenna of claim 11, wherein the feeding part is arranged between the main ground part and the variable ground part, and one end portion of the main ground part or the variable ground part is connected to an antenna end.

13. The antenna of claim 11, wherein the main ground part and the variable ground part are arranged adjacent to each other, and the feeding part is connected to the main ground part or the variable ground part.

14. The antenna of claim 13, wherein the main ground part and the variable ground part are arranged between the feeding part and the antenna end.

15. The antenna of claim 13, wherein the feeding part is connected in a direction toward the antenna end from the main ground part or the variable ground part.

16. The antenna of claim 11, wherein a lower resonant frequency is realized when the switch terminal portion operates the feeding part connection element, and a higher resonant frequency is realized when the switch terminal portion operates the ground part connection element.

17. The antenna of claim 16, wherein each of the feeding part connection element and the ground part connection element is provided by at least one.

18. The antenna of claim 16, wherein the feeding part is connected with a matching circuit for a control of an input impedance, and the feeding part connection element is arranged by being connected to a front or rear side of the matching circuit.

19. The antenna of claim 18, wherein the variable ground part is provided by at least two, and the at least two variable ground parts are selectively connected via a switch terminal disposed between the feeding part and the matching circuit and the respective impedance control circuits.

20. The antenna of claim 11, wherein changes in the impedance are made by the feeding part connection element or the ground part connection element, and the feeding part connection element and the ground part connection element are inductors or capacitors.

21. (canceled)
